(19) United States
(12) Patent Application Publication
(10) Pub. No.: US 2013/0032978 A1
(43) Pub. Date: Feb. 7, 2013

(54) Burner Gland For An Electric Arc Furnace

(71) Applicant: Joshua W. Glass, Charlevoix, MI (US)

(72) Inventor: Joshua W. Glass, Charlevoix, MI (US)

(73) Assignee: NU-CORE, INC., Charlevoix, MI (US)

(21) Appl. No.: 13/564,343

(22) Filed: Aug. 1, 2012

Related U.S. Application Data
(60) Provisional application No. 61/513,852, filed on Aug. 1, 2011.

(51) Int. Cl. F27D 11/08

(52) U.S. Cl. 266/241

(57) ABSTRACT

A burner enclosure for use in locating a burner in an a wall of an electric arc furnace, the burner enclosure includes a plurality of walls wherein each wall includes a serpentine cooling path therein and an inlet located proximal a first edge of each wall and an outlet located proximal a second edge of each wall and wherein the walls are assembled into the burner enclosure so an inlet of one wall can be connected by an elbow to an outlet of an adjoining wall to create a cooling fluid flow path through the entire burner enclosure to improve the performance of the burner in the burner enclosure and to improve the overall efficiency of the electric arc furnace.

### CROSS REFERENCE TO RELATED APPLICATIONS

This application claims the benefit of, and incorporates herein by reference for all purposes, U.S. Provisional Patent Application No. 61/513,852 entitled Burner Gland For Electric Arc Furnace, to Joshua W. Glass and filed on Aug. 1, 2011.

### FIELD

The invention generally relates to an improved liquid cooled forged copper burner gland for holding a burner or lance to inject oxygen into an electric arc furnace during the steel making process and more particularly to a more efficient cooling arrangement for a burner gland enclosure for the supply of oxygen which is blown into a bath of molten steel.

### BACKGROUND

In general, the art of steel making has been very highly refined. Historically, electric arc furnaces are used to make steel by application of an electric arc to melt scrap metal and/or other raw iron products and alloys that are placed within the furnace.

In order for the electric arc furnace to melt the material into molten metal, the electrical current arcs from the electrodes to the scrap metal and/or other raw iron products and back thereby raising its temperature and melting the material. Electric arc furnaces need to reach temperatures of approximately 2500°-3000° F. in order to melt iron. These relatively hot temperatures result in excessive wear of the refractory brick material as well as the furnace structure resulting in rapid deterioration of the furnace and very costly shut down periods in order to allow the furnace to cool before excessively worn areas can be repaired or replaced.

These problems have led to significant efforts to attempt to provide varying types of arc furnaces, in terms of wall and roof constructions which are less costly and have extended life. These efforts have also led to advances which have focused upon devices which can either cool the refractory material of the furnace similar to U.S. Pat. No. 5,426,664 by Grove, owned by the common assignee hereof and entitled “Water Cooled Copper Panel for a Furnace and Method of Manufacturing Same,” or completely replace the refractory material with a material which can withstand such temperatures.

When an electric arc furnace operates the charged scrap is rapidly melted at the hot spots, regions of highest electric current density, but often remains un-melted at the cold spots. Scrap located at the cold spots receives heat from the electric arc at a reduced rate during the melt down cycle, thereby creating cold spots. Prior art solutions to the formation of cold spots have been to incorporate fixed burner glands or boxes around the furnace to apply additional sources of heat to the cold spots. Electric arc furnaces using fixed burners located at cold spots have improved uniformity of scrap melting and reduce build-up of materials at the cold spots. When additional heat sources such as burner enclosures are placed in the electric arc furnace, their location is chosen to avoid further overheating of hot spots resulting from the rapid melting of scrap located between the electrodes and the furnace shell. More specifically, the burners are located as far away from hot spots as in particularly possible and the burner flame outlet opening direction is chosen so that flame penetration occurs mainly into the scrap pile located at the cold spots and not to already heated portions of the furnace.

Further heating and processing is realized by a decarburization process wherein in typical advanced prior art or modern electric arc furnace techniques, a high velocity, usually supersonic flow of oxygen is blown into the metal bath with either lances or burners/lances to decarburize the bath by oxidation of the carbon contained in the bath forming CO and/or CO2. The burners/lances act more uniformly to melt the charge, lessen or prevent overheating, minimize the melt time, and minimize the arc operation time, all factors that increase the efficiency of the steel making process.

It has long been known that the use of cooling panels in an electric arc furnace increases the refractory sidewall life to at least twenty-five times that of normal refractory material. Development and practical use of water cooled elements for interior walls as a replacement for standard refractory walls, above the hot metal zone, has reduced the non-productive time delays and has significantly improved the operating economy of electric arc furnaces. Simultaneously, furnace components such as the above mentioned burner gland or burner boxes have also commanded attention to combat heat related problems. Generally, designers of such components use water cooled devices and panels through which a constant flow of cooling fluid is directed close to the surfaces that are exposed to heat, to help dissipate the heat. The cooling fluid thus cools the panels, from the inside and lowers the temperature of the device which aids in the overall efficiency of the steel making process.

Taken in connection with the improvements to the art field in the design and operation of metal melting furnaces have been improvements in burner panel design. Some such patents teaching and disclosing various burner panel configurations include, but are not limited to U.S. Pat. Nos. 4,703,336; 5,44,733; 6,212,218; 6,372,010; 5,166,950; 5,471,495; 6,289,035; 6,614,831; 5,373,530; 5,802,097; 6,999,495; and 6,342,086. Such prior art patents have been beneficial. For example, U.S. Pat. No. 6,999,495 has found wide applicability for increasing spatial energy coverage in a furnace. Likewise, U.S. Pat. No. 6,614,831 has found applicability in extending the reach of various tools, such as a burner or a lance, into the interior of a furnace. However, the art field is in search of further improved apparatuses and method for the melting of metals.

Most fluid cooled devices use a serpentine arrangement to direct water through the device. While such arrangements are often effective at cooling furnace components, they are not sufficiently efficient and often allow hot spots to develop. One reason why the serpentine arrangement is not efficient is that as the water flows through the device, small bubbles often form along the walls of the water pipes. These bubbles can insulate a portion of the pipe and prevent the water from cooling the device efficiently. Further, where two pipes join the end caps of a serpentine arrangement is an important area of concern for an efficient and safe operation of an electric arc furnace component. At this junction, liquid coolants experience a sharp 180° turn and a change in fluid pressure. The change in fluid pressure at the junction can be caused by a slower speed of flow, a drop in flow volume, a greater friction between the liquid and the surface of the end caps, a formation of air bubbles, a formation of vapors, a dead flow area, a collection of mineral deposits due to the irregular shape of the welding compounds, a turbulent flow, and a greater heat accumulation due to a slower rate of thermal conductivity. A simple remedy for some of those potential problems which can be caused by junctions in a flow path is to simply increase the flow of water through the pipe. This may help resolve some of the problems, i.e. wash away the bubble formations, but it requires significant higher water flow and pressure, thereby increasing the cost of the operation.

Therefore, what is needed is a burner gland/box enclosure having an outer configuration which can be modified to fit an existing opening in the wall of the electric arc furnace. The burner enclosure provides a central passage adapted to receive a lance or burner injecting oxygen into the bath of molten metal of an electric arc furnace. The coolant flow in the burner enclosure reduces turbulent fluid flow, reduces or eliminates the formation of bubbles and vapors in the coolant, and enhances the thermal conductivity of the furnace liquid cooling system.

### SUMMARY OF THE INVENTION

The invention provides a burner enclosure for a burner lance for use in an electric arc furnace and including an improved cooling system configuration and thereby enhancing the thermal efficiency of the burner gland and the overall efficiency of the electric arc furnace.

In one exemplary embodiment, the burner enclosure is an arrangement fabrication from wall forgings which are machined and welded together into a burner gland or burner box having a through-hole in one side of the burner gland that can be adapted to receive a lance or burner for providing oxygen to an electric arc furnace. In one exemplary embodiment copper forged wall elements can be used although stainless steel wall forging can alternately be used in place of copper. Further, it's foreseen that other materials with comparable characteristics can also be used. Within at least one wall, and in each wall in one exemplary embodiment, of the burner enclosure structure including the burner gland there is included a serpentine and/or contoured flow passage having an coolant fluid inlet and coolant fluid outlet located at or near an edge of the wall. With the inlet and outlet located at or near the edge of each wall, when the burner gland structure is assembled, the outlet in one wall can be aligned with an inlet of an adjoining wall such that coolant fluid can flow from one wall to another wall. In one exemplary embodiment, the burner gland enclosure can vary in physical size and construction and can be adapted to fit into varying location sizes, including existing openings, within the electric arc furnace.

In general, the copper walls are arranged approximately perpendicular to each other and welded together into a box structure having walls which vary in length and shape. The walls can be made using any known or appropriate manufacturing method including, but not limited to, forging. Because of the strategic location in each wall of the inlet and outlet of the serpentine/contoured cooling passage, when the burner gland box is completely welded together, an outlet from a first wall will be adjacent to an inlet from another wall which may be transversely oriented to the first wall within the interior of the box-like structure.

To establish a continuous cooling passage through all four or more walls of the box-like structure an elbow connection can have one end coupled to the outlet from a first wall and another end coupled to the inlet from another adjoining wall and the couplings can be made watertight. In one exemplary embodiment, the elbow connection is preferably made from copper using any known or appropriate process, such as forging, and can be coupled using any known or appropriate process, such as welding, to the adjoining walls. Each outlet from a wall adjacent an inlet from an adjoining wall can be provided with an elbow connection such that upon completion of the watertight perimeter welding, a continuous passage is established between the serpentine/contoured internal passages of the walls of the burner box so that cooling of the burner gland can be accomplished in the walls of the box-like structure through the continuous serpentine passage arrangement within the walls and the watertight elbow connections between adjacent walls.

Cooling water is supplied to the burner box through a cooling water inlet extending from the outer periphery of the burner gland. The inlet communicates with the serpentine inner flow passage of one of the walls of the box structure. Likewise, a single outlet communicates with the serpentine/contoured continuous flow passage of the burner gland assembly to discharge the heated cooling water to a nearby collection basin.

### BRIEF DESCRIPTION OF THE DRAWINGS

FIG. 1 is a front view of a burner gland of the invention in a fully assembled state;

FIG. 2 is a partial sectional view of the mounting arrangement of the invention in the furnace wall of an electric arc furnace;

FIG. 3 is a side view of FIG. 1 and illustrates the right side plate of the burner enclosure welded to the roof section at the top thereof; the front section with burner opening and the bottom plate; and

FIG. 4 is a cross-sectional view of the roof section taken along arrow X-X of FIG. 3.

### DETAILED DESCRIPTION OF THE PREFERRED EMBODIMENT

The present disclosure relates to a burner enclosure for an oxygen lance or burner which is durable and not prone to erosion and cracking or weld failures while providing better strength and more efficient heat transfer which can be used in new and existing furnaces. The burner enclosure has particular application in electric arc furnaces for making steel. The burner enclosure includes wall having a serpentine passage therein for providing a coolant fluid flowing through the burner enclosure thereby reducing and/or eliminating stalling and hot spots within the walls of the burner enclosure and thereby increasing the life of the burner, the burner enclosure and other parts of the furnace.

The burner enclosure of the present disclosure can better maintain a uniform cooling water flow through the burner enclosure to reduce and/or eliminate stalling and turbulence in critical areas and can reduce and/or prevent any solid deposits from clogging cooling passages.

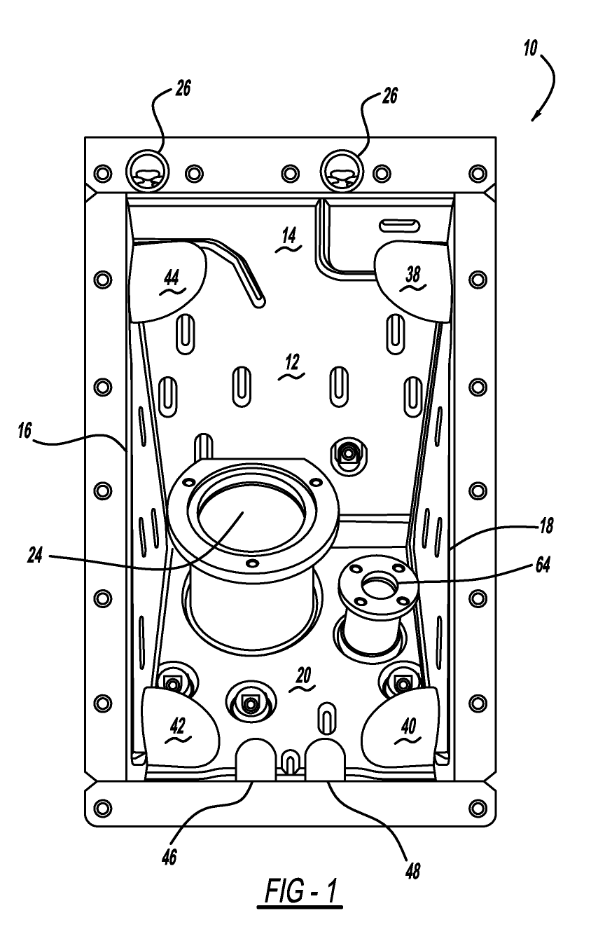

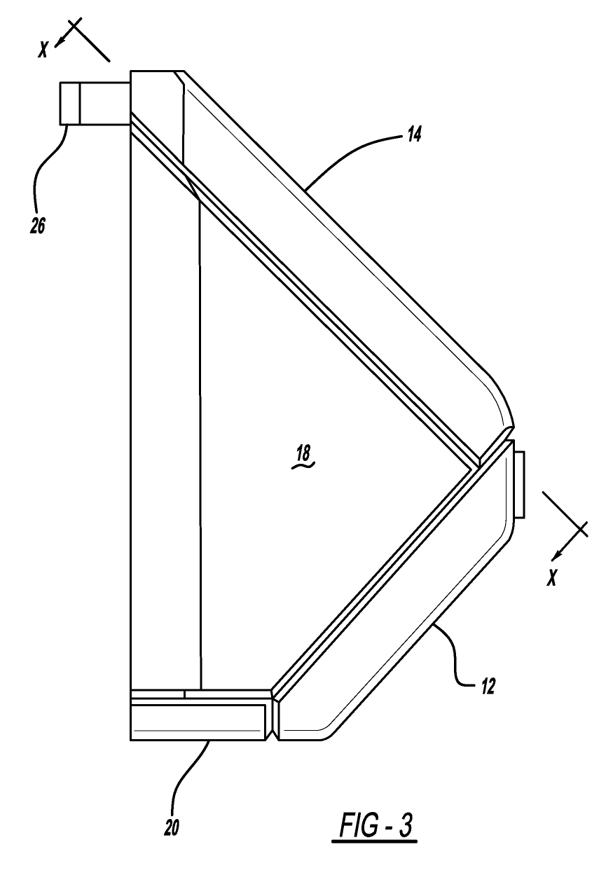

Referring in general to all of the Figures, and in particular to FIGS. 1 and 3, there is disclosed and exemplary embodiment of a burner enclosure 10 consisting of a burner housing 10, shown as including five sides but may have other constructions. The five walls of the enclosure 10 can include a front section or wall 12, a roof section or wall 14, first or right side section or wall 16, second or left side section or wall 18 and bottom section or wall 20. Each wall of the housing 10 can be welded to its adjacent walls to complete the enclosure 10. Each wall 12,14,16,18 and 20 can have machined edges that are aligned with adjacent wall sides and clamped together during construction and thereafter each wall can be welded along their edges to form the completed burner enclosure 10. The roof section 14 is welded to the top ends of the left 18, right 16 and front 12 sections and the bottom section 20 is welded to the lowest side ends of the right 16, left 18 and front 12 as best shown in FIG. 3. The front section 12 includes a burner opening 24 as best shown in FIG. 1 and completes the enclosure housing 10 between the roof section 14 and bottom plate 20 as best shown in FIG. 3. Other arrangements of the burner enclosure housing 10 are expressly contemplated herein.

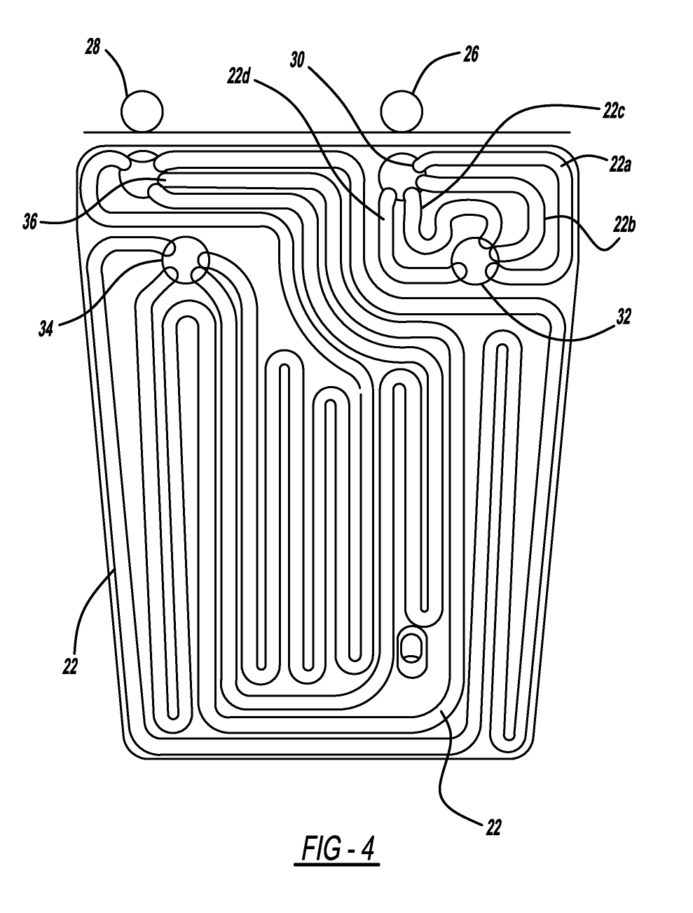

In one exemplary embodiment, each wall 12,14,16,18 and 20 of the burner enclosure 10 can be formed, machined or otherwise manufactured to include uniform cooling passages 22 as best shown in FIG. 4. In the one exemplary embodiment, each wall 12, 14, 16, 18 and 20 of the enclosure 10 includes a series of continuous flow uniform passages 22 but it should be understood that it can be only one, or it could be more than one, wall of the walls 12, 14, 16, 18 and 20 that includes cooling passages 22 therein. By way of example, the roof section 14, as best shown in FIG. 4, includes a plurality of serpentine passages 22 therein. Each passage 22 can communicate with an inlet 34 located near one edge or end and an outlet 32 located at or near another or opposite edge or end as best shown in FIG. 4. The roof section 14 also includes a burner housing

In the exemplary embodiment shown, each wall 12, 14, 16, 18 and 20 of the burner enclosure 10 includes an inlet 26 and an outlet 28 located near an edge of each wall so that when the burner enclosure 10 is assembled, as best shown in FIG. 1, the outlet 28 in one wall (e.g., left wall 18) will be adjacent the inlet 26 of an adjoining wall (e.g., bottom wall 20). Since the burner enclosure 10 is intended as a replacement part for an existing burner unit, it is designed to be surrounded by a single water source inlet 26 as well as a single water source outlet 28.

Depending upon the overall size and configuration of any one wall of the wall sections 12, 14, 16, 18, and 20 that make up the burner enclosure 10, the routing of the continuous coolant flow in the passage 22 of the wall is not necessarily from one wall section to the next wall section. Selective cooling paths can be utilized to obtain selective and proper cooling of the various areas of a particular wall section. FIG. 4 includes an example wherein the water supply inlet 26 can have cooling water enter into a chamber 30 that communicates the cooling water into water passages 22a, 22b, 22c, and 22d. The cooling water flows along passages 22a, 22b, 22c and 22d into an outlet 32 within the roof wall section 14. The outlet passage 32 of roof 14 communicates with an inlet passage 26 in the left wall section 18. The cooling water flow continues through the left side wall 18 cooling passage 22 into the outlet 32 in the lower part of the left side wall 18. The lower outlet 32 in the left side wall 18 communicates with an inlet 34 in the front wall section 12 where the cooling water can enters into the cooling passages 22 within the front wall section 12 and can then exit through the outlet 32 of the front wall 12 and can be communicated with the inlet 34 in the right wall section 16. After the cooling water enters the inlet 34 at the bottom of the right wall section 16 it can flow upward through the passages 22 within the right wall section 16 to the outlet 32 at the top of the right wall section 16 and can then, be communicated with a further inlet 34 in the roof section 14 and can then be communicated with the remainder of the cooling passages 22 in the roof section 14 to cool the roof section 14 and exit the roof section 14 through an exit chamber 36 into the water outlet 28 to a collection area (not shown) where the water is allowed to cool and can then be reused.

The front wall section 12 also has an additional inlet and outlet that communicates with the passage 22 in the bottom plate 20 to convey cooling water to the bottom plate 20. Although it would be possible to provide a separate water source inlet and outlet for each wall of the walls 12, 14, 16, 18 and 20, the required separate plumbing for such an arrangement would be extremely cumbersome and costly and would likely create additional problems because of space limitations surrounding electric arc furnace. Therefore, the present exemplary embodiment provides flexibility in that it can use a single inlet and outlet for the burner enclosure 10 or it can be designed to use more than one inlet and outlet for selective aspects of the burning enclosure 10 as a particular application may require.

As set forth above, each wall 12, 14, 16, 18 and 20 of the burner enclosure 10 has an inlet 26 and an outlet 28 strategically placed near an edge of each wall so that when the burner enclosure 10 is assembled, such as by welding in the exemplary embodiment shown, into an assembly as shown in FIG. 1, the outlet 28 in one wall will be adjacent the inlet 26 of the adjoining wall as described above. The continuous uniform passage throughout the walls 12, 14, 16, 18 and 20 of the burner enclosure 10 can be accomplished by providing an elbow connection 38, 40, 42, 44, 46 and 48, as best shown in FIG. 1, between the outlet 32 of the one wall and the inlet 34 of the adjoining wall.

An elbow 38 is placed over the outlet 32 of the roof section 12 and over the inlet 34 of the left wall 18 and is coupled to the walls such as by having its perimeter-welded to create a continuous passage between the uniform cooling passages 22 of the roof wall 14 and the uniform cooling passages 22 of the left wall 18 so that when all elbows 38, 40, 42, 44, 46 and 48 are installed and coupled within the burner enclosure 10, the uniform cooling passages from each wall 12, 14, 16, 18 and 20 form a single uniform cooling passage 22 through all of the walls 12, 14, 16, 18 and 20 of the burner enclosure 10 and can be supplied by the water source inlet 26 and the cooling water can exit the water source outlet 28 and can provide cooling to the entire burner enclosure 10.

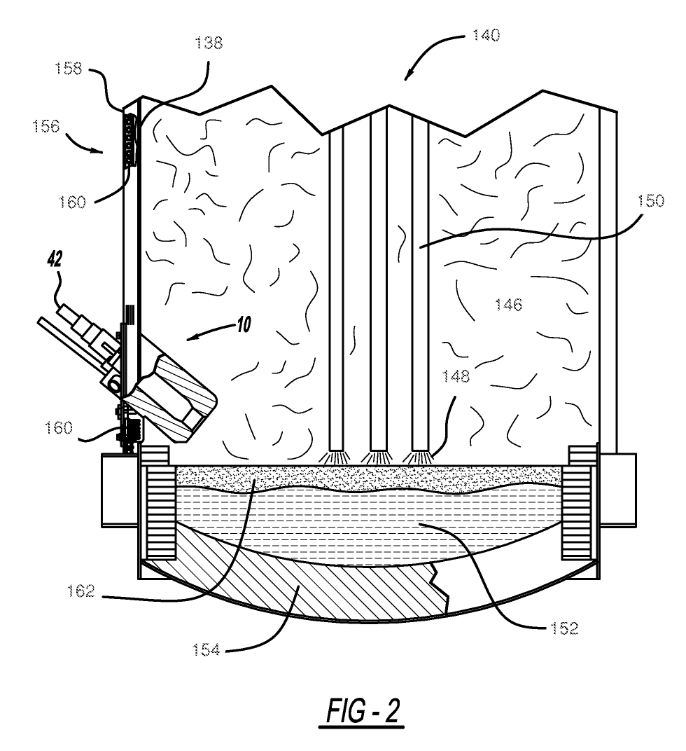

As best illustrated in FIGS. 1 and 2, after complete assembly, the burner enclosure 10 can be mounted to a sidewall 138 of a shell of an electric arc furnace 140 and can include a burner lance 142 mounted in the burner mounting tube 24 located in the front wall section 12 of the burner enclosure 10. Depending on the configuration of the furnace 140, the burner enclosure 10 can be mounted anywhere in the sidewall 138 of the furnace 140. Further, the furnace 140 may have more than one burner enclosure 10 mounted around its periphery, depending upon its size, configuration, and melting power. Generally, the burner enclosure 10 can be located at a cold spot in the furnace 140 to assist with the melting of the charge 152. The cold spots can be different for DC (direct current) furnaces 140, which usually having one electrode, and for AC (alternating current) furnaces 140, which usually have three electrodes, and can also be different within these furnaces depending on its size, manufacturer and operating procedure.

The burner enclosure 10 can be adapted to operate in several different modes to provide auxiliary heating, metal refining, and other processing capabilities in electric arc furnaces (EAF) 140, or similar metal melting, refining, or processing furnaces. In FIG. 2, which illustrates a partial side view, the electric arc furnace 140 melts ferrous scrap 46 by means of an electric arc 48 produced from one or more electrodes 150 to collect as a molten metal melt 152 at its lowest point or hearth 154. The hearth 154 can be made of refractory material to withstand the intense heat of the molten metal 152. The hearth 154 can be surrounded by an upper wall housing which consists of a series of arcuate fluid cooled panels 156. The fluid cooled panels 156 can be of several different conventional arrangements such as illustrated in the preferred embodiment with an outer shell member 158 and a plurality of cooling coils 160. The charge or molten metal melt 152 can be generally covered with varying amounts of slag 162 as a result of chemical reactions between the molten metal melt 152 and the slag forming materials added to the furnace during the melting process of the charge 146.

The burner enclosure 10 can be mounted through an opening in the fluid cooling coils 160 of the wall 158 of the furnace 140. The burner enclosure 10 can be fluid cooled and generally can be bolted into some form of mounting plate or rectangular shaped mounting block usually retro-fitted to an existing furnace or integrated into the wall of a newly designed furnace. The burner enclosure 10 can be received into a mounting aperture of the mounting plate so that the discharge opening of the burner lance mounted within the central disposed through-passage or opening 24 of the burner housing 10 can be extended beyond the edge of the refractory hearth 154. This permits the flow of materials from the discharge opening of the burner lance to not interfere with the refractory material so that degradation of the refractory material can be avoided. Since the burner enclosure 10 can be fluid cooled, it can withstand the high temperatures of the internal areas of the furnace 140. This allows the burner enclosure 10 to be brought closer to the molten metal melt 152 and so that it can be more efficient in its operation. The burner enclosure 10 can be slanted downward at an angle, preferably between 20-50 degrees, to direct the flange of the burner lance towards the molten metal melt 152 in the hearth 154 of the furnace 140. In addition to its downward inclination, the burner enclosure 10 can also be angled or directed from a normal or radial position to be preferably 0-20 degrees tangential.

The burner enclosure 10 can be designed to receive a burner lance 42, shown in FIG. 2, mounted in a mounting tube 24 attached to the front section wall 12 of the burner housing 10 as shown in FIG. 1. The burner housing 10 can accommodate a variety of burner lances 42 from various manufacturers. The mounting tube 24 can be customized to receive various sizes and configurations of burner lances 42.

The burner enclosure can be used with burner lances 42 that include water cooling passages surrounding the gas and fuel supply passages and can be used with other types of burner lances 42 that have no coolant passages and will therefore rely entirely on the water cooling arrangement of the burner enclosure 10.

The burner lance 42 is supplied with two utilities from an oxidizing gas supply and a fuel supply (not shown). The oxidizing gas supply provides commercially pure oxygen, although a mixture of oxygen with air or another gas is not uncommon. The fuel supply is generally natural gas but here again, a combination of fuel fluids or gases maybe used. The burner housing 10 may optionally have a longitudinal through-tube 64 as shown in FIG. 1 which serves to provide the particular supply, ranging from slag forming materials to metallurgical materials. The operation and timing of these various utilities is generally controlled by a programmed logic controller as is well known in the prior art.

In order to obtain a more uniform coolant velocity, avoid turbulence, and/or prevent solid deposits from clogging along any of the cooling passages 22 of the walls 12, 14, 16, 18 and 20 of the burner enclosure 10, there are certain cross-sectional area relationships that are preferably established and maintained. For example, the effective cross-sectional areas of the inlet 34 and outlet 32 in each of the walls 12, 14, 16, 18 and 20 of the burner enclosure 10 as well as the chambers is designed to be at least equal to that of the combined respective uniform passage inlet or outlets that communicate with each inlet, outlet or chamber to assume uniform coolant flow. Uniform flow helps avoid stalling and turbulence in the areas of the burner enclosure 10, which can cause premature failure in copper castings that do not utilize an internal cooling coil. Uniform flow within the walls 12, 14, 16, 18 and 20 of the burner enclosure 10 also allows for higher velocity flow of the coolant fluid so that solid deposits are prevented from clogging cooling the passages 22 of the walls 12, 14, 16, 18 and 20.

While the invention has been described in connection with a preferred embodiment, the specification is not intended to limit the scope of the invention to the specific embodiment discussed. On the contrary, it is intended to cover any alternatives, modifications and equivalents as may be included within the spirit and scope of the invention as defined by the appended claims.

What is claimed:

1. A burner enclosure apparatus for use in an electric arc furnace, the burner enclosure apparatus comprising:
a plurality of burner walls wherein each wall is coupled to another wall along an edge to form said burner enclosure;
each wall of the plurality of burner walls including at least one cooling passage therein having an inlet located proximal a first edge of the wall and an outlet located proximal a second edge of the wall;
a burner opening located in at least one wall of the plurality of burner walls;
a burner coupled to the burner opening; and
an elbow coupling having a first end coupled to the inlet of a first wall of the plurality of walls and a second end coupled to an outlet of a second wall of the plurality of walls and wherein the cooling passage of the first wall is coupled to the cooling passage of the second wall to create a continuous cooling passage through each wall of the plurality of walls for conveying a cooling fluid through the walls of the burner enclosure.

2. The burner enclosure apparatus of claim 1 wherein each wall of the plurality of walls is a forged wall and the cooling passage is a serpentine shaped passage formed in the wall.

3. The burner enclosure apparatus of claim 1 further comprising a single inlet coupling for receiving a coolant fluid inlet supply and a single outlet coupling for conveying the coolant fluid our of the burner enclosure apparatus.

4. The burner enclosure apparatus of claim 1 comprising five walls including a roof wall section coupled to the top ends of a left wall section, a right wall section and a front wall section; the five walls further including a bottom wall section welded to the lowest side ends of the right wall section, the left wall section and the front wall section.

5. The burner enclosure apparatus of claim 1 wherein the burner opening is located in the front wall section.

6. A burner enclosure apparatus comprising:
a burner enclosure defining a plurality of burner walls attached to each other along contiguous edges to form the burner enclosure, the burner enclosure comprising:
a plurality of wall sections, each wall section having an outer surface; an inner surface located with respect to the outer surface;
at least one cooling passage between the inner surface and the outer surface of each wall section; and
wherein each cooling passage of each wall section including an inlet juxtaposed an edge of the wall section and an outlet juxtaposed another edge of the wall section; and
a plurality of elbow connections coupled to the inside surfaces of said plurality of wall sections, each of said plurality of elbow connections including a first end coupled to an inlet of one wall section and a second end coupled to an outlet of another wall section whereby each of the plurality of elbow connections and the plurality of wall sections creates a continuous cooling passage through each wall of the plurality of wall sections defining the burner enclosure.

7. The burner enclosure apparatus of claim 6 further comprising:
a burner opening located in at least one wall of the plurality of burner walls; and
a burner coupled to the burner opening.

8. The burner enclosure apparatus of claim 7 further comprising an electric arc furnace.

9. The burner enclosure apparatus of claim 6 wherein the plurality of wall sections comprises five wall sections including a roof wall section coupled to the top ends of a left wall section, a right wall section and a front wall section, the five wall sections further including a bottom wall section welded to the lowest side ends of the right wall section, the left wall section and the front wall section.

10. The burner enclosure apparatus of claim 7 wherein the plurality of wall sections comprises five wall sections including a roof wall section coupled to the top ends of a left wall section, a right wall section and a front wall section, the five wall sections further including a bottom wall section welded to the lowest side ends of the right wall section, the left wall section and the front wall section.

11. The burner enclosure apparatus of claim 10 wherein the burner opening is located in the front wall section.
